(19) United States
(12) Patent Application Publication
(10) Pub. No.: US 2003/0224113 A1
(43) Pub. Date: Dec. 4, 2003

(54) Solution film-forming method, cellulose ester film, protective film and polarizing plate

(76) Inventors: Toshikazu Nakamura, Minami-Ashigara (JP); Hidekazu Yamazaki, Minami-Ashigara (JP)

Correspondence Address: BIRCH STEWART KOLASCH & BIRCH, PO BOX 747, FALLS CHURCH, VA, 22040-0747, US

(21) Appl. No.: 10/453,532

(22) Filed: Jun. 4, 2003

(30) Foreign Application Priority Data
Jun. 4, 2002 (JP) 2002-163274

(51) Int. Cl. B05D 3/02

(52) U.S. Cl. 427/372.2

(57) ABSTRACT

A solution film-forming method including the steps of forming a film from a polymer solution in which a polymer is dissolved in an organic solvent transporting the film formed and passing the film through a drying area in which the film is heated to volatilize the organic solvent in the film to obtain a polymer film, wherein the film is passed through the drying area under the condition of −0.05≦εMD-εTD<+0.15, where a degree of stretching of the film in the transport direction within the drying area during transport is expressed as εMD and a degree of stretching of the film in the width direction within the drying area during transport is expressed as εTD.

### BACKGROUND OF THE INVENTION

1. Field of the Invention

The present invention relates to a solution film-forming method including forming a film from a polymer solution in which a polymer is dissolved in an organic solvent, transporting the film formed, and passing it through a drying area to heat the film to evaporate the organic solvent in the film, thereby obtaining a polymer film, and relates to a cellulose ester film formed by the solution film-forming method, a protective film for polarizing plate applications made of the cellulose ester film, and a polarizing plate using the protective film.

2. Description of the Related Art

Polymer films have been used as optical materials such as an optical functional film to widen a viewing angle and prevent glare and a polarizing plate protective film for a liquid crystal display device. The polymer films for use in these optical materials desirably have a small optical anisotropy. The reduction of the optical anisotropy of polymer films requires manufacturing polymer films having molecules similarly aligned both in longitudinal and lateral directions. For manufacturing polymer films, a method called a solution film-forming method may be used. The solution film-forming method includes forming a film from a polymer solution in which a polymer such as a cellulose ester is dissolved in an organic solvent and heating the film formed to evaporate the organic solvent in the film, thereby obtaining a polymer film. In forming a film from a polymer solution, the polymer solution is continuously discharged on a support to form a long film. The long film passes through a drying area to heat the film and is transported to a winding machine to wind the film in a roll form. The drying area may include an area in which plural rolls are disposed and the film is transported looped over the plural rolls. The solution film-forming method will be capable of manufacturing polymer films having molecules similarly aligned both in longitudinal and lateral directions, if excessive tension is not applied to the film.

For improving production efficiency, a film is desirably transported in a speed as high as possible in a solution film-forming method. The higher transport speed tends to increase transport tension of the film. For example, in a drying area in which plural rolls are disposed, if the transport speed is increased while maintaining the transport tension of the film, air may be trapped between the film and the peripheral surface of the rolls, thereby causing a slip of the film on the peripheral surface of the rolls. At this time, if foreign matters got caught between the film and the peripheral surface of the rolls, the film might be scratched to impair the commercial value. To prevent the slip, the use of a so-called dimple roll that has micro asperities on the roll surface or the application of knurlings at the edges of the film can be devised. However, as these measures lead to an increase in the cost of the equipment, the increase of the transport speed generally involves transporting the film at a higher transport tension.

However, excessively high transport tension may stretch the film, causing the alignment of the molecules in the polymer film to be different between in a longitudinal direction and in a lateral direction. The film tends to be stretched easily particularly in a drying area, as it is heated in the area.

### SUMMARY OF THE INVENTION

The present invention has been made in view of the above circumstances and provides a solution film-forming method, a cellulose ester film, a protective film and a polarizing plate. It is an object of the present invention to provide a solution film-forming method in which production conditions to obtain a polymer film having a small optical anisotropy are established, a cellulose ester film formed by the solution film-forming method, a protective film for polarizing plate applications made of the cellulose ester film, and a polarizing plate using the protective film.

The solution film-forming method of the present invention to achieve the above described object includes a solution film-forming method including forming a film from a polymer solution in which a polymer is dissolved in an organic solvent, transporting the film formed, and passing the film through a drying area in which the film is heated to volatilize the organic solvent in the film to obtain a polymer film, in which the film is passed through the drying area under the condition that −0.05≦εMD-εTD≦+0.15, where a degree of stretching of the film in the transport direction within the drying area during transport is expressed as εMD and a degree of stretching of the film in the width direction within the drying area during transport is expressed as εTD.

The solution film-forming method of the present invention provides, as one of the production conditions in a drying area, a relational expression using two parameters, that is, the degree of stretching in the transport direction and that in the width direction. The stretch of the film within the drying area is controlled by the two parameters, thereby preventing the film from being excessively stretched only in the transport direction between the transport and width directions to allow production of a polymer film having a small optical anisotropy.

The solution film-forming method of the present invention preferably has an aspect in which in the step of drying the film at high temperature to reduce residual solvent performed within the drying area, the aspect ratio X of the span of pass rolls to the film width is in the range of 0.95≦X≦1.6.

The film width is determined by the specification of a polymer film to be produced, but the span of the pass rolls can be freely set. A longer span of pass rolls may increase the transport pass length of the film and may increase the drying time, resulting in the film to be easily stretched in the transport direction. In this aspect, plural rolls are arranged in the drying area such that the peripheral surfaces of the respective rolls are opposed to each other up and down. More specifically, when the rolls which are opposed to each other up and down have a center distance (span of pass rolls) of L and the film during transport has a width (film width) of W, the plural rolls are arranged in two upper and lower rows so that Land W are in the range of 0.95≦L/W≦1.6. Thereby, the film can be dried sufficiently, while preventing the film from excessively stretched only in the transport direction between the transport and width directions.

In the solution film-forming method of the present invention, a transport tension is preferably from 3.5 to 16 kgf/l m of film width in the step of drying the film at high temperature to reduce residual solvent performed within the drying area.

Thus, transporting the film such that the film transport tension is from 3.5 to 16 kgf per 1 m of the film width allows the film to be transported in a high speed in the range the optical anisotropy is not influenced, thereby being capable of improving the production efficiency.

Furthermore, in the solution film-forming method of the present invention, preferably, a quantity of the residual solvent at the entrance of the drying area is 8% or less, in the step of drying the film at high temperature to reduce residual solvent performed within the drying area, or a drying temperature is 150° C. or less in the step of drying the film at high temperature to reduce residual solvent performed within the drying area.

If the residual weight of the organic solvent in the film is larger than 8% relative to 100% of the solid content in the film, or if the drying temperature is higher than 150° C. in the case of forming the film from a cellulose ester solution in which the cellulose ester is dissolved in the organic solvent, the film is too soft and tends to be easily elongated. The control of the residual solvent at 8% or less or of the drying temperature at 150° C. or less can prevent the film during transport from being excessively stretched.

The cellulose ester film of the present invention to achieve the above described object is characterized in that it is formed by the solution film-forming method of the present invention; the protective film of the present invention to achieve the above described object is characterized in that it is for polarizing plate applications made of the cellulose ester film of the present invention; and the polarizing plate of the present invention to achieve the above described object is characterized in that it uses the protective film of the present invention.

As described above, the present invention can provide a solution film-forming method in which production conditions to obtain a polymer film having a small optical anisotropy are established, a cellulose ester film formed in the solution film-forming method, a protective film for polarizing plate applications made of the cellulose ester film, and a polarizing plate using the protective film.

### BRIEF DESCRIPTION OF THE DRAWINGS

Preferred embodiments of the present invention will be described in detail based on the following figures, wherein:

FIG. 1 illustrates a schematic view of a production line during production of a cellulose film by casting a polymer solution on a cylindrical drum; and

FIG. 2 illustrates a schematic view of a production line during production of a cellulose film by casting a polymer solution on an endless belt.

### DETAILED DESCRIPTION OF THE PREFERRED EMBODIMENTS

Embodiments of the present invention will now be described below.

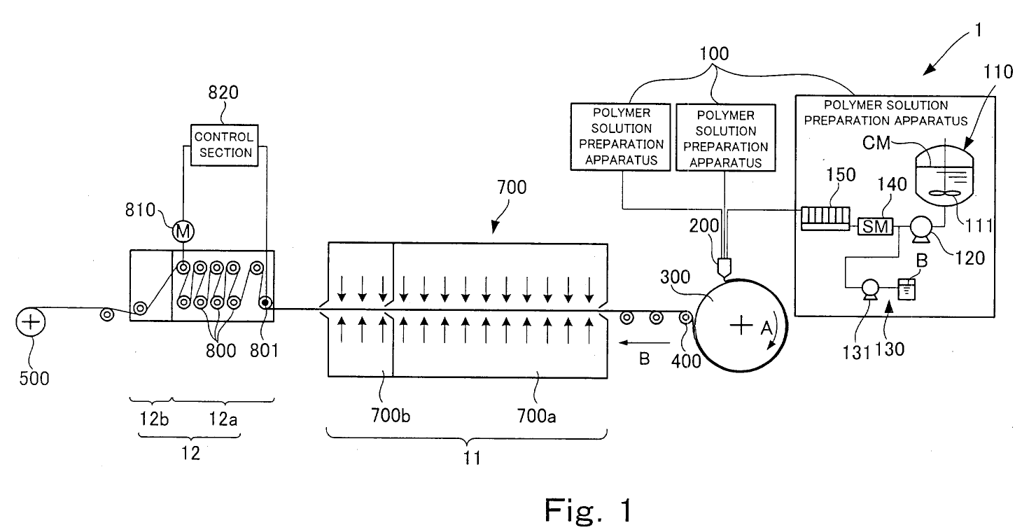

In the embodiments of the solution film-forming method of the present invention, a polymer solution is cast on a support to produce a polymer film. There are two types of supports on which the polymer solution is cast, that is, a cylindrical drum and an endless belt. Referring first to FIG. 1, the production line to produce the polymer film by casting the polymer solution on the cylindrical drum will now be described.

FIG. 1 illustrates a schematic view of the production line during production of the polymer film by casting the polymer solution on a cylindrical drum.

The production line 1 shown in FIG. 1 is the production line of a TAC (triacetyl cellulose) film, which is one embodiment of the solution film-forming method of the present invention. A polymer solution preparation apparatus 100, a casting die 200, a casting drum 300, and a peeling roll 400 are disposed in this order, from the upstream of the production line 1.

The production line 1 has three polymer solution preparation apparatuses 100, each preparing different types of polymer solution. Here, the polymer solution preparation apparatus 100 shown in the right side in FIG. 1 will be described as an example. In the polymer solution preparation apparatus 100, a polymer solution of triacetyl cellulose is prepared. For preparing the polymer solution, triacetyl cellulose is dissolved in a solvent containing dichloromethane as a main component, and a small amount of n-butanol is added to the solution in which triacetyl cellulose is dissolved. N-butanol has a higher boiling point than dichloromethane. In addition, triacetyl cellulose has poorer solubility in n-butanol than in dichloromethane. The polymer solution preparation apparatus 100 is provided with a storage tank 110, a delivery pump 120, a poor solvent supply device 130, a static mixer 140, and a filter 150. In the storage tank 110, a mix solution CM of dichloromethane and methanol in which triacetyl cellulose is dissolved is stored while agitated by an agitator blade 111. A plasticizer is also dissolved in the mix solution CM. In the production line 1 shown in FIG. 1, the prepared polymer solution is continuously discharged on the peripheral surface of the casting drum 300 to form a long film, and the film formed is transported toward the downstream side. For transporting the film, the film preferably has good flexibility, and the plasticizer is added to improve the toughness of the film. The solution CM stored in the storage tank 110 is sent to the casting die 200 by the delivery pump 120, the static mixer 140 and the filter 150 being disposed in the delivery path. The poor solvent supply device 130 delivers n-butanol B through a delivery pump 131 to the static mixer 140, where n-butanol B is added and mixed to the mix solution CM. Note that n-butanol may be added in the storage tank 110 without using the poor solvent supply device 130. The solution discharged from the static mixer 140 is delivered to the casting die 200, with foreign matters and undissolved raw materials in the solution removed through the filter 150.

Polymer solutions prepared in each of the three polymer solution preparation apparatuses 100 are supplied to the casting die 200. More specifically, among the three polymer solution preparation apparatuses, the polymer solution preparation apparatus 100 illustrated in the right side in FIG. 1 delivers the polymer solution to form a front side layer of the film, the polymer solution preparation apparatus 100 illustrated in the center delivers the polymer solution to form a center portion of the film, and the polymer solution preparation apparatus 100 illustrated in the left side delivers the polymer solution to form a back side layer of the film. Each of the polymer solutions delivered is discharged from a discharge port of the casting die 200. Note that the number of the polymer solution preparation apparatus 100 is not limited to three, but may be one or two, or four or more, depending on the specification of the TAC film to be produced.

The casting drum 300 rotates in the direction of the arrow A. The casting die 200 is disposed over the casting drum 300 such that the discharge port opposes the peripheral surface of the casting drum 300.

Each of the polymer solutions discharged from the discharge port of the casting die 200 is co-cast on the peripheral surface of the casting drum 300 rotating in the direction of the arrow A. The polymer solution discharged on the peripheral surface of the casting drum 300 is cooled from the inside of the peripheral surface of the casting drum 300 to promote gelation while air is blown from the outside to promote drying, forming a film having self-supporting properties. When reaching the position where the peeling roll 400 is provided, the film is peeled at the peeling roll 400.

A winding machine 500 to wind the transported film into roll form is disposed at the utmost downstream of the production line 1 shown in FIG. 1. In addition, between the peeling roll 400 and the winding machine 500, there are provided a soft film drying zone 11 and a post-drying zone 12, both zones being provided to evaporate the solvent in the film. The film peeled at the peeling roll 400 is transported in the direction of the arrow B by two driven rolls through the soft film drying zone 11 the post-drying zone 12, and then wound on the winding machine 500.

The film peeled at the peeling roll 400 is sent to the soft film drying zone 11. A tenter 700 is provided in the soft drying zone 11. The tenter 700 is a box, and not-shown clips, which grip each of the both edges of the film from the both sides of the film, are traveling from the upstream toward the downstream inside the box. The film sent into the tenter passes through the tenter 700 while gripped at its both edges by the clips. Clips at the both edges are traveling at the same speed while maintaining the parallel relationship with respect to each other. The inside of the tenter 700 is divided into a volatilization space 700a and a cooling space 700b. The volatilization space 700a is the space where high temperature air is blown on the film during transport so as to volatilize the organic solvent in the film. The temperature of the blowing air increases as the film travels closer to the downstream, and the blowing temperature at the downstream is 150° C., which is higher than the boiling point of the organic solvent and lower than the temperature where triacetyl cellulose starts to be thermally decomposed. Thus, the organic solvent in the film sent into the volatilization space 700a gradually volatilizes as the film travels closer to the downstream. The cooling space 700b is the space located adjacent to the downstream end of the volatilization space 700a, where low temperature air is blown on the film during transport to be cooled. The film sent into the cooling space 700b is cooled to room temperature, and then carried out from the tenter 700.

At the time when co-cast on the peripheral surface of the casting drum 300, the polymer solution contains 300% or more of the organic solvent relative to 100% of the weight of the solid content of triacetyl cellulose and the plasticizer. However, the organic solvent in the film volatilizes while passing through the volatilization space 700a, so that the solvent contained in 300% or more is reduced to only 5% to 8% in the film carried to the inlet of the post-drying zone 12. In the upstream side 12a of the post-drying zone 12, the film is heated again to volatilize the organic solvent contained in 5% to 8%. Plural rolls 800 are provided in the upstream side 12a, and the film is transported looped over the plural rolls 800. In the upstream side 12a of the post-drying zone 12, for transporting the film by looping over the plural rolls 800, the film is transported under the production condition of −0.05<εMD-εTD≦+0.15, where the degree of stretching of the film in the transport direction within the upstream side 12a during transport is expressed as εMD, and the degree of stretching of the film in the width direction within the upstream side 12a during transport is expressed as εTD. Note that the degree of stretching herein is defined by the length of the film at the upstream side outlet relative to the unit length of the film at the upstream side inlet, that is, the rate of elongation at the upstream outlet of the film relative to the length of the film at the upstream inlet of “1”. In the upstream side 12a, various measures to be described below have been taken to satisfy the production condition.

High temperature air is blown on the film during transport to heat the film in the upstream side 12a. The heating temperature of the film is suppressed to 150° C. or less. By suppressing the heating temperature to 150° C. or less, triacetyl cellulose will not reach the glass transition point, preventing the film from becoming too flexible. As a result, the film can be prevented from being excessively stretched.

The plural rolls 800 are arranged in two upper and lower rows such that the peripheral surfaces of the respective rolls are opposed up and down. The length of the plural rolls 800 corresponds to the width W of the film and is determined by the specification of the polymer film to be produced, so that the length of each roll 800 is naturally determined. On the other hand, the center distance L of the rolls which are opposed to each other up and down can be freely set irrespective of the film width W. However, although the longer center distance L may increase the transport path length of the film, increasing the heating time, the film may tend to be easily stretched in the transport direction. In the upstream side 12a of the post-drying zone 12, these plural rolls 800 are arranged in two upper and lower rows so as to be in the range of 0.95≦L/W≦1.6. As a result, in this upstream side 12a, the film can be dried sufficiently, while preventing the film during transport from excessively stretched only in the transport direction between the transport and width directions.

In addition, among these plural rolls 800, the roll rotatively driven by a motor is only the one disposed at the utmost downstream, and other rolls are freely rotated but not rotatively driven by itself. However, plural rolls that are rotatively driven by a motor may be disposed. A motor 810 is coupled to the roll disposed at the utmost downstream, and the roll disposed at the utmost upstream has a built-in tension meter 801. In addition, the roll disposed at the utmost downstream has suction function, so that it rotates by a driving force of the motor 810 with the film absorbed to the peripheral surface of the roll, transporting the film to the downstream side. Therefore, in this upstream side 12a, the tension given to the film varies depending on the magnitude of the running torque of the roll disposed at the utmost downstream. The tension meter 801 measures the tension of the film passing on the roll disposed at the utmost upstream. Hereinafter, the tension measured by the tension meter 801 is referred to as the transport tension. The tension meter 801 is connected with the motor 810 via a control section 820. The control section 820 adjusts the running torque of the motor 810 so that the transport tension is always maintained within the range of from 3.5 to 16 kgf per 1 m of the film width. If the transport tension is too large, the film might be stretched in the transport direction. If the transport speed is increased while maintaining the transport tension, air might be trapped between the film and the peripheral surface of the roll 800, thereby causing a slip of the film on the peripheral surface of the roll 800. At this time, if foreign matters get caught between the film and the peripheral surface of the roll 800, the film might be scratched to impair the commercial value. In the upstream side 12a, the upper limit of the transport tension of the film during transport is set at 16 kgf/1 m of the film width in order to prevent the film during transport from being excessively stretched only in the transport direction between the transport and width directions, and the lower limit of the transport tension of the film is set at 3.5 kgf/1 m of the film width so as to prevent the slip, increasing the transport speed of the film in order to secure the minimum production efficiency.

N-butanol added and mixed in the polymer solution preparation apparatus 100 has the highest boiling point among the substances contained in the solvent, so that it is least volatile and most likely to remain in the solvent among the substances contained in the solvent. In addition, as triacetyl cellulose has poorer solubility in n-butanol than in dichloromethane, the intermolecular bond of n-butanol with triacetyl cellulose is less easily produced than that of dichloromethane with triacetyl cellulose. In the solvent where n-butanol is added and mixed, the intermolecular bond of dichloromethane with triacetyl cellulose is broken by the action of n-butanol, enhancing the volatilization of dichloromethane. Further, the remaining n-butanol is also less liable to produce the intermolecular bond with triacetyl cellulose, so that it is not easily to be bound to triacetyl cellulose. As the quantity of the n-butanol added is small, it will be volatilized by the end of passing through the upstream side 12a of the post-drying zone 12 and will not influence the film properties.

The film is cooled down close to room temperature in the downstream side 12b of the post-drying zone 12, and the film has a product form of a TAC film.

The film (TAC film) sent out from the post-drying zone 12 is wound on the winding machine 500.

The thus produced TAC film is sent to not-shown post steps and commercialized as an optical functional film such as a protective film for polarizing plate or an antireflective film. Furthermore, the protective films for polarizing plate are laminated on both sides of the polarizing element formed from polyvinyl alcohol or the like, forming a polarizing plate, or the polarizing plate is used to constitute a part of a liquid crystal display device.

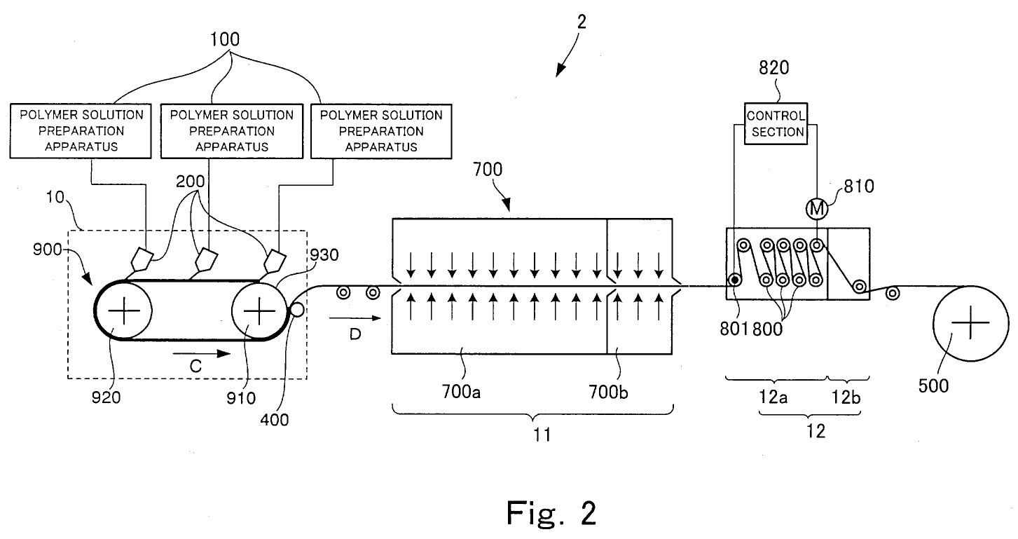

Referring then to FIG. 2, the production line to produce a polymer film by casting a polymer solution on an endless belt will now be described.

FIG. 2 illustrates a schematic view of a production line during production of a cellulose film by casting a polymer solution on an endless belt.

The production line 2 shown in FIG. 2, similar to the production line l shown in FIG. 1, is also the production line of a TAC (triacetyl cellulose) film, which is one embodiment of the solution film-forming method of the present invention, wherein a casting band 900 is disposed instead of the casting drum 300 disposed in the production line 1 shown in FIG. 1. The production line 2 will be described below with a focus on the difference from the production line 1 shown in FIG. 1, using the same symbols to the same components as the production line 1 in shown FIG. 1.

The production line 2 shown in FIG. 2 has three polymer solution preparation apparatuses 100 similar to the three polymer solution preparation apparatuses shown in FIG. 1 and three casting dies 200. Each of the three polymer solution preparation apparatuses 100 is connected in a one-to-one relationship with each of the three casting dies 200. In addition, these three casting dies 200, the casting band 900 and a peeling roll 400 are provided in a drying room 10. Note that each of the three polymer solution preparation apparatuses 100 is not necessarily connected in a one-to-one relationship with each of the three casting dies 200, but the polymer solution prepared in one polymer solution preparation apparatus 100 may be divided to be supplied to each of the plural casting dies with separate pumps. Further, the polymer solution may be co-cast using one casting die as described referring to FIG. 1, without providing the casting dies 200 in plural numbers.

The casting band 900 has an endless band 930 looped over a driving drum 910 and a driven drum 920. The belt 930 travels in circulation in the direction of the arrow C in the drying room 10. The three casting dies 200 are disposed over the belt 930 along the traveling direction of the belt 930 such that the discharge ports oppose the surface of the belt 930.

The polymer solution sent to each of the casting dies 200 is sequentially cast on the surface of the belt 930 traveling in circulation in the direction of the arrow C, and the solvent is gradually volatilized while the belt 930 travels in circulation in the drying room 10, forming a film having self-supporting properties. In other words, the volatilization of the solvent makes a film having shape stability. After the belt 930 has traveled in approximately one circulation, the film is peeled at the peeling roll 400 and sent to a soft film drying zone 11 (refer to the arrow D in FIG. 2). The soft film transport zone 11 and thereafter in the production line 2 shown in FIG. 2 is similar to the soft film transport zone and thereafter in the production line 1 shown in FIG. 1.

The preparation of a polymer solution will now be described in detail. In the preparation of a polymer solution performed in the polymer solution preparation apparatuses 100 shown in FIGS. 1 and 2, triacetyl cellulose is dissolved in the organic solvent containing dichloromethane as a main component in the storage tank 110, and triphenyl phosphate is also dissolved as a plasticizer.

Triacetyl cellulose is a mixture of those synthesized from woodpulp and those synthesized from cotton linters, and contains 60% by weight of those synthesized from woodpulp and 40% by weight of those synthesized from cotton linters. Thus, containing those synthesized from woodpulp as a main component can reduce the cost of the TAC film. Note that in the present invention the ratio of those synthesized from woodpulp to those synthesized from cotton linters may be of any value, not limited to the above described ratio.

Dichloromethane has good compatibility with triacetyl cellulose, so that the total quantity of the solvent relative to triacetyl cellulose can be suppressed by using dichloromethane as a main component in the organic solvent.

Plasticizer are not limited to triphenyl phosphate, and may include phosphate compounds other than triphenyl phosphate such as tricresyl phosphate, cresyl diphenyl phosphate, octyl diphenyl phosphate, diphenyl biphenyl phosphate, trioctyl phosphate and tributyl phosphate; phthalate compounds such as diethyl phthalate, dimethoxyethyl phthalate, dimethyl phthalate, dioctyl phthalate, dibutyl phthalate and di-2-ethylhexyl phthalate; and glycolate compounds such as triacetin, tributyrin, butyl phthalyl butyl glycolate, ethyl phthalyl ethyl glycolate, methyl phthalyl ethyl glycolate and butyl phthalyl butyl glycolate. Two or more of these compounds may be used in combination as the plasticizer.

The organic solvent in the storage tank 110 contains methanol. The addition of methanol improves the shape stability (self-supporting properties) of the film to be peeled by the peeling roll 400, facilitating the transport of the film. Note that ethanol may be mixed in place of methanol. Further, additives such as UV absorbers or antidegradants are dissolved in the organic solvent in the storage tank 110.

n-butanol as a poor solvent is added such that it is contained in an amount of from 0.1% by weight to 4.0% by weight relative to 100% by weight of the total amount of solvent in the polymer solution prepared in the polymer solution preparation apparatus 100. Note that in the production line 1 in which a casting drum 300 is disposed as a support shown in FIG. 1, the addition quantity of the poor solvent need not be limited to such extent, and the extent, and the type of the poor solvent to be added may be the alcohol having a boiling point of from 80 to 170° C., other than n-butanol. Further, in the production line 2 shown in FIG. 2 in which a casting band 900 is disposed as a support, the poor solvent need not necessarily be added.

A method for producing a TAC film has been described, in which the film is produced from a polymer solution in which triacetyl cellulose is dissolved in a solvent containing dichloromethane as a main component. However, the solution film-forming method of the present invention may include the use of the organic solvent such as lower aliphatic alcohols or chlorides of lower aliphatic hydrocarbons other than dichloromethane, as a main component of the solvent. Examples include, but are not limited to, alcohols having from 1 to 6 carbon atoms such as methanol, ethanol, n-propanol, iso-propanol, 1-butanol, t-butanol, 2-methyl-2-butanol, 2-methoxy ethanol and 2-butoxy ethanol; and chloroform. In addition, the main component of the solvent may include ketones such as acetone substantially containing no halogenated hydrocarbon, for example, ketones having from 4 to 12 carbon atoms such as methyl ethyl ketone, diethyl ketone, diisobutyl ketone, cyclohexanone and methyl cyclohexanone. Further, the main component of the solvent may also include esters having from 3 to 12 carbon atoms (for example, ethyl formate, propyl formate, pentyl formate, methyl acetate, ethyl acetate, propyl acetate, butyl acetate, pentyl acetate and 2-ethoxy-ethyl acetate), ethers having from 3 to 12 carbon atoms (for example, diisopropyl ether, dimethoxymethane, dimethoxyethane, 1,4-dioxane, 1,3-dioxolane, tetrahydrofuran, anisole and phenetole), and cyclic hydrocarbons having from 5 to 8 carbon atoms (for example, cyclopentane, cyclohexane, cycloheptane and cyclooctane). Furthermore, the solute may include a cellulose ester other than triacetyl cellulose or a polycarbonate. For example, cellulose diacetate (DAC), cellulose acetate butyrate and cellulose acetate propyonate may be used as fatty acid esters of cellulose having 6 or less carbon atoms.

### EXAMPLES

TAC films were produced applying the solution film-forming method of the present invention, and the optical anisotropy of the TAC films was evaluated. The results of the examples together with comparative examples will be described referring to Table 1.

TABLE 1

| | | | | | | | | | |
|---|---|---|---|---|---|---|---|---|---|
| | | | | | | | | Comparative | Comparative |
| Example 1 | Example 2 | Example 3 | Example 4 | Example 5 | Example 6 | Example 7 | Example 8 | Example 1 | Example 2 |

| | | | | | | | | | | |
|---|---|---|---|---|---|---|---|---|---|---|
| Aspect Ratio | 1.3 | 1.6 | 1.6 | 0.95 | 0.95 | 0.95 | 1.3 | 1.6 | 0.9 | 1.8 |
| Transport | 12 | 12 | 16 | 12 | 6 | 3.5 | 8 | 16 | 3 | 18 |
| Tension | | | | | | | | | | |
| (kgf/lm | | | | | | | | | | |
| width) | | | | | | | | | | |
| Residual | 5 | 8 | 8 | 5 | 8 | 8 | 3 | 3 | 8 | 10 |
| Solvent | | | | | | | | | | |
| Quantity (wt % | | | | | | | | | | |
| (dry base)) | | | | | | | | | | |
| Drying | 145 | 145 | 145 | 145 | 145 | 145 | 140 | 140 | 145 | 145 |
| Temperature | | | | | | | | | | |
| (° C.) | | | | | | | | | | |
| εMD-εTD | 0.06 | 0.12 | 0.15 | 0.02 | −0.02 | −0.05 | 0.06 | 0.15 | −0.07 | 0.18 |
| Film | 80 | 80 | 80 | 80 | 80 | 80 | 40 | 40 | 80 | 80 |
| Thickness | | | | | | | | | | |
| (μm) | | | | | | | | | | |
| Retardation | 3 | 6 | 8 | 3 | 6 | 8 | 3 | 8 | 10 | 10 |
| Value (nm) | | | | | | | | | | |
| Direction of | MD | MD | MD | TD | TD | TD | MD | MD | TD | MD |
| Optical | | | | | | | | | | |
| Orientation | | | | | | | | | | |
| Axis | | | | | | | | | | |
| Presence or | Non | Non | Non | Non | Non | Non | Non | Non | Yes | Non |
| Absence of | | | | | | | | | | |
| Scratches | | | | | | | | | | |

For preparing a polymer solution in all of the eight examples and two comparative examples to be described below, 20 parts by weight of triacetyl cellulose, 2.2 parts by weight of triphenyl phosphate as a plasticizer, 1.1 parts by weight of biphenyl diphenyl phosphate, and 0.02 parts by weight of a UV absorber were used. In addition, in all examples, the solvent was prepared such that it contains 79.6% by weight of dichloromethane, 19.9% by weight of methanol and 0.5% by weight of n-butanol relative to 100% by weight of the polymer solution prepared in the polymer solution preparation apparatus 100.

First, as examples of the solution film-forming method of the present invention, TAC films were produced using the production line 1 shown in FIG. 1 under eight production conditions combining four conditions consisting of the center distance L/film width W (aspect ratio) for the rolls 800 disposed in the upstream side 12a of the post-drying zone 12, the transport tension of the film at the upstream side 12a of the post-drying zone (unit: kgf/lm of film width), the quantity of the residual solvent of the film transported to the inlet of the post-drying zone 12 (unit: % by weight (dry base)), and the drying temperature at the upstream side 12a of the post-drying zone (unit: ° C.) (Examples 1 to 8).

In the comparative examples, TAC films were produced combining these four conditions under the same conditions as examples except that two kinds of production conditions each different from the production conditions for each of the examples were used (Comparative Examples 1 and 2).

For performing each of the examples and each of the comparative examples, the film was marked with a predetermined spacing in the transport direction, at a position between the soft film drying zone 11 and the post-drying zone 12. The extent of the increase of the spacing was measured at a position between the post-drying zone 12 and the winding machine 500. From the results of the measurements, the degree of stretching in the transport direction within the upstream side 12a of the post-drying zone of the film during transport (EMD) was determined. In addition, the length of the film in the width direction at a position between the soft film drying zone 11 and the post-drying zone 12 and the length of the film in the width direction at a position between the post-drying zone 12 and the winding machine 500 were measured. From the results of the measurements, the degree of stretching in the width direction within the upstream side 12a of the post-drying zone of the film during transport (ETD) was also determined.

The optical anisotropy of the TAC films produced in each of the above examples and comparative examples was evaluated by determining the retardation value (Re). The retardation value (Re) will be lower for a higher optical isotropy, and the retardation value of the film which can be used for a protective film for polarizing plate is 8 nm or less, desirably 6 nm or less. For determining the retardation value (Re) of each of the TAC films, the thickness of each of the TAC films after drying (d) (unit: μm) was measured, and the refractive index (nx) in the slow axis direction in the plane of each of the TAC films at a wavelength of 632.8 nm and the refractive index (ny) in the direction perpendicular to the slow axis in the plane of each of the TAC films at a wavelength of 632.8 nm were measured using KOBRA-21DH made by Oji Scientific Instruments. The retardation value (Re) of each of the TAC films was calculated by formula (1) below:

Re=(nx−ny)×d (1)

In addition, the direction of optical orientation axis of the TAC films produced in each of the examples and comparative examples (transport direction (MD), film width direction (TD)) was observed, and the presence or absence of scratches on each of the TAC films was also observed.

In Table 1, these four conditions, (the degree of stretching of the film in the transport direction within the upstream side 12a of the post-drying zone during transport)−(the degree of stretching of the film in the width direction within the upstream side 12a of the post-drying zone during transport) (εMD-εTD), the measured thickness of the TAC film after drying (unit: μm), the calculated retardation value (unit: nm), the direction of the optical orientation axis and the presence or absence of scratches are shown for each of the examples and comparative examples in each column.

As shown in Table 1, the TAC films produced in any examples had a retardation value of 8 nm or less and no scratches. On the other hand, both of the TAC films produced in comparative examples had a retardation value of 10 nm and the TAC film produced in Comparative Example 2 had scratches. Among eight examples, the minimum of the εMD−εFTD values is −0.05 and the maximum is 0.15. On the other hand, the εMD-εTD value for Comparative Example 1 is −0.07, and for Comparative Example 2 it is 0.18. These results indicate that a retardation value of 8 nm or less requires a value of εMD-εTD of from −0.05 to +0.15. In addition, in terms of the four conditions, it is understood that the value of εMD-εTD of from −0.05 to +0.15 requires an aspect ratio of from 0.95 to 1.6, a transport tension of from 3.5 kgf/1 m width to 16 kgf/1 m width, and a residual solvent quantity of 8% by weight (dry base) or less. Further, it is understood that the drying temperature may be 150° C. or less. Furthermore, it is understood that a retardation value of 6 nm or less requires a value of εMD-εTD of from −0.02 to +0.12.

What is claimed is:

1. A solution film-forming method comprising the steps of:
forming a film from a polymer solution in which a polymer is dissolved in an organic solvent;
transporting the film formed; and
passing the film through a drying area in which the film is heated to volatilize the organic solvent in the film to obtain a polymer film, wherein
the film is passed through the drying area under a condition of approximately −0.05≦εMD-εTD≦ approximately +0.15, where a degree of stretching of the film in the transport direction within the drying area during transport is expressed as EMD and a degree of stretching of the film in the width direction within the drying area during transport is expressed as εTD.

2. The solution film-forming method according to claim 1, wherein in the step of drying the film at high temperature to reduce residual solvent performed within the drying area, an aspect ratio X of the span of pass rolls to the film width is in the range of approximately 0.95≦X≦ approximately 1.6.

3. The solution film-forming method according to claim 1, wherein in the step of drying the film at high temperature to reduce residual solvent performed within the drying area, a transport tension is from approximately 3.5 to approximately 16 kgf/1 m of film width.

4. The solution film-forming method according to claim 2, wherein in the step of drying the film at high temperature to reduce residual solvent performed within the drying area, a transport tension is from approximately 3.5 to approximately 16 kgf/1 m of film width.

5. The solution film-forming method according to claim 1, wherein in the step of drying the film at high temperature to reduce residual solvent performed within the drying area, the quantity of the residual solvent at the inlet of the drying area is approximately 8% or less.

6. The solution film-forming method according to claim 2, wherein in the step of drying the film at high temperature to reduce residual solvent performed within the drying area, the quantity of the residual solvent at the inlet of the drying area is approximately 8% or less.

7. The solution film-forming method according to claim 3, wherein in the step of drying the film at high temperature to reduce residual solvent performed within the drying area, the quantity of the residual solvent at the inlet of the drying area is approximately 8% or less.

8. The solution film-forming method according to claim 4, wherein in the step of drying the film at high temperature to reduce residual solvent performed within the drying area, the quantity of the residual solvent at the inlet of the drying area is approximately 8% or less.

9. The solution film-forming method according to claim 1, wherein in the step of drying the film at high temperature to reduce residual solvent performed within the drying area, the drying temperature is approximately 150° C. or less.

10. The solution film-forming method according to claim 2, wherein in the step of drying the film at high temperature to reduce residual solvent performed within the drying area, the drying temperature is approximately 150° C. or less.

11. The solution film-forming method according to claim 3, wherein in the step of drying the film at high temperature to reduce residual solvent performed within the drying area, the drying temperature is approximately 150° C. or less.

12. The solution film-forming method according to claim 4, wherein in the step of drying the film at high temperature to reduce residual solvent performed within the drying area, the drying temperature is approximately 150° C. or less.

13. The solution film-forming method according to claim 1, wherein the polymer solution comprises a cellulose ester solution.

14. The solution film-forming method according to claim 2, wherein the polymer solution comprises a cellulose ester solution.

15. The solution film-forming method according to claim 3, wherein the polymer solution comprises a cellulose ester solution.

16. The solution film-forming method according to claim 4, wherein the polymer solution comprises a cellulose ester solution.

17. A cellulose ester film formed by the method according to claim 13.

18. A protective film for polarizing plate applications made of the film according to claim 17.

19. A polarizing plate using the film according to claim 18.
